(19) United States
(12) Patent Application Publication
(10) Pub. No.: US 2013/0314921 A1
(43) Pub. Date: Nov. 28, 2013

(54) EXPLOSION-PROOF LAMP WITH HEAT DISSIPATION MECHANISM

(71) Applicant: TOP HI-TECH CO., LTD., New Taipei City (TW)

(72) Inventor: Chang-Nan CHEN, New Taipei City (TW)

(73) Assignee: TOP HI-TECH CO., LTD., New Taipei City (TW)

(21) Appl. No.: 13/775,845

(22) Filed: Feb. 25, 2013

(30) Foreign Application Priority Data
May 23, 2012 (TW) 101209749

(51) Int. Cl. F21V 29/00; F21V 15/01

(52) U.S. Cl. CPC F21V 29/20; F21V 15/011
USPC 362/249.02; 362/382; 362/249.01; 362/373

(57) ABSTRACT

An explosion-proof lamp with a heat dissipation mechanism includes a lamp base, a heat dissipater and a lighting module. The heat dissipater further includes a heat dissipation body having a foundation and a column block extended from the foundation; wherein the cross-sectional size of the foundation is greater than the one of the column block. A fastening means is provided between the foundation and the lamp base such that the foundation is fastened onto the lamp base via the fastening means. The lighting module is secured onto the column block. With such novel design, the heat dissipation effect of the explosion-proof lamp is advantageously improved.

### BACKGROUND OF THE INVENTION

1. Field of the Invention

The present invention relates to an explosion-proof lamp, and in particular, to an explosion-proof lamp with a heat dissipation mechanism.

2. Description of Related Art

As industrial sites and places including such as semi-conductor manufacturing factories, gasoline and chemical production plants and mining sites are often stored with explosive gases or flammable dusts, it is imperative to use explosive-proof lamps for the lighting fixtures in such places to prevent hazardous occurrence of explosions or burning caused by accidental flams or overheated high surface temperature due to improper settings in such as switch on or off of power, overloading or aging wires adapted in the internal circuitries or electronic components of light fixtures.

In order to meet with the demand for energy-saving and environmental friendly requirements and trends, current explosion-proof lamps mostly utilize lighting elements constructed by light emitting diodes (LED) with the merits of lower voltage, less power consumption, higher electro-light conversion rate and longer lifetime to replace traditional lamps with high power consumptions such as high-pressure sodium lamps or metal halide lamps. Nevertheless, the utilization of LEDs generates a great amount of heat, which tends to damage the electronic components on the internal circuit boards mounted with the LEDs. In addition, such great amount of heat would also cause the LEDs to have shorter lifetime and greater light decays. As a result, there are explosion-proof lamps developed to include a heat dissipation mechanism to increase the rate of heat transfer from the lighting unit such that the useful lifetime of the explosion-proof lamps is increased.

Please refer to FIG. 1 showing a cross-sectional view of a known explosion-proof lamp with a heat dissipation mechanism. The known explosion-proof lamp with a heat dissipation mechanism 9 comprises a lamp base 90, at least one lighting unit 91, a lens 92, a circular cap 93 and a plurality of heat dissipation fins 94. The lighting unit 91 is a LED and the lighting unit 91 is mounted inside the lamp base 90. The lens 92 is arranged correspondingly with the lamp base 10 to cover the lighting unit 91. The circular cap 92 is attached to the lamp base 90 and suppresses the lens 92 onto the lamp base 90 such that the lens 92 is firmly attached to the lamp base 90. Each one of the heat dissipation fins 94 is provided on the lamp base 90 and away from one end of the lighting unit 91; and wherein heat generated by the lighting unit 91 is transferred to each one of the heat dissipation fins 94 via the lamp base 90 and further undergoes heat exchange with the air via each one of the heat dissipation fins 94 in order to achieve the effect of heat dissipation of the lighting unit 91.

However, such known explosion-proof lamp with a heat dissipation mechanism 9 exhibits at least the following drawbacks. First of all, the heat generated by the lighting unit 91 cannot be transferred out effectively over a certain period of time due to the design that the wall of the lamp base 90 in contact with the lighting unit 91 is relatively thin, which leads to the accumulation of heat and damages the lighting 91 eventually. If the thickness of the wall of the lamp base 90 is increased, the volume of the explosion-proof lamp 9 has to be increased, too, which is likely to cause difficulties to the manufacturing and assembly of the lamp base 90. Secondly, due to the nature of the illumination of LEDs is rather straight and focused with the largest possible illumination angle of 120 degree for most conventional LEDs, it is common to find dark corners or ineffective lighting to unnecessary illuminated areas for LED lamps without satisfying the needs of users and the later causes unnecessary waste of resources, too. To overcome the aforementioned problems, manufacturers are constantly investing in the development of new products and the burden of the manufacturers is increased significantly, too.

### SUMMARY OF THE INVENTION

The present invention is to provide an explosion-proof lamp with a heat dissipation mechanism utilizing a lighting module secured onto a column body of a heat dissipater which also includes a foundation having a different cross-sectional size from the one of the column body thereof in order to enhance the heat dissipation effect of the lamp.

Accordingly, the present invention provides an explosion-proof lamp with a heat dissipation mechanism comprising a lamp base, a heat dissipater, a fastening means and a lighting module. The heat dissipater comprises a heat dissipation body, and the heat dissipation body comprises a foundation and a column block extended from the foundation; wherein a cross-sectional size of the foundation is greater than a cross-sectional size of the column block. The fastening means is provided between the foundation and the lamp base, the foundation being screwed onto the lamp base via the fastening means. The lighting module is secured onto the column block.

The present invention exhibits the following merits and technical effects. First, by coating a heat conductive medium between the outer surface of the foundation and the inner wall of the receiving room, the contact area between the outer surface of the foundation and the receiving room is increased such that the effect of heat transfer thereof is enhanced. Second, by securing each one of the lighting units circumferentially around the surface of the column block, the overall volume of the explosion-proof lamp can be remained without any increase when the volume of the column block is increased such that the material and manufacturing costs can be reduced. Third, by securing each one of the lighting units within each one of the indented groove, the lighting units can be kept at a proper distance away from the light shell such that the illumination of the explosion-proof lamp is uniform. Fourth, one may alter the design of the heat dissipater of the explosion-proof lamp based on user's needs without remaking and molding of the explosion-proof lamp all over again such that the costs and time required for molding designs, certifications and manufacturing can be significantly reduced, which can lower the storage quantity of the lamp base and the cap, too. Fifth, the lighting units can be secured onto the column block of the heat dissipater either partially or circumferentially in order to obtain different light distribution curves such that the heat dissipater can be exchanged according to different needs of illumination areas to obtain a desired light distribution curve for the explosion-proof lamp and such that the light provided by the lighting units can be utilized effectively to achieve the effect of energy and cost saving. Sixth, the size, depth and angle of the indented grooves can be varied according to the needs of different light source types and the amount of illumination such that the light shone from the lighting units can be of various angles and directions without different lighting effects once the lighting units are secured onto the column block.

### BRIEF DESCRIPTION OF DRAWING

FIG. 1 is a cross-sectional view of a conventional explosion-proof lamp with a heat dissipation mechanism;

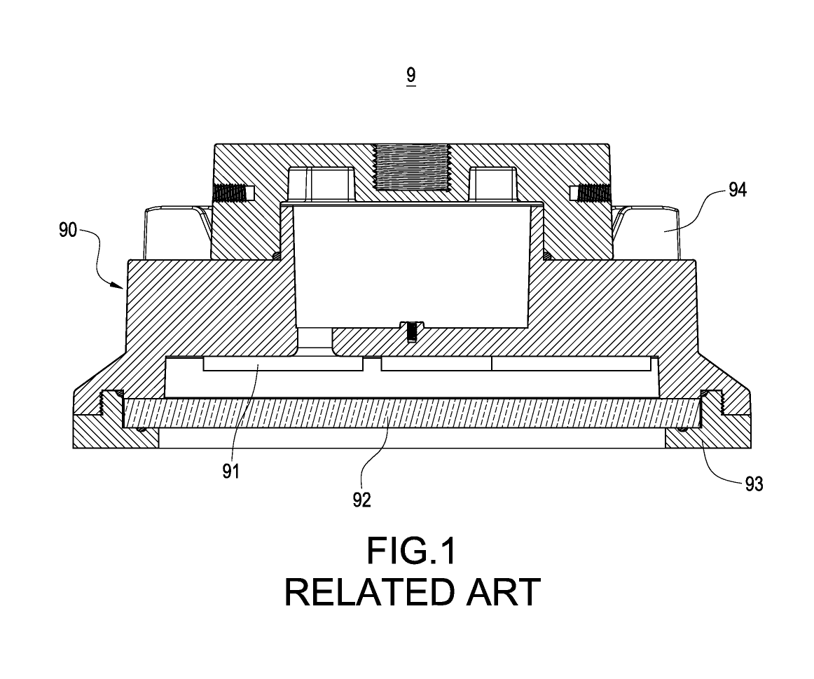

FIG. 2 is an exploded view of a first embodiment of the present invention;

FIG. 3 is a perspective view showing an assembled first embodiment of the present invention;

FIG. 4 is a perspective view of the heat dissipater of the first embodiment of the present invention;

FIG. 5 is a cross-sectional view of an assembled first embodiment of the present invention;

FIG. 6 shows a first column block illustration of the first embodiment of the present invention;

FIG. 7 shows a second column block illustration of the first embodiment of the present invention;

FIG. 8 shows a third column block illustration of the first embodiment of the present invention;

FIG. 9 shows a fourth column block illustration of the first embodiment of the present invention;

FIG. 10 is an illustration showing a state of use of the first embodiment of the present invention;

FIG. 11 is a perspective view of a second embodiment of the present invention; and

FIG. 12 is a cross-sectional view of an assembled third embodiment of the present invention.

### DETAILED DESCRIPTION OF THE INVENTION

Detailed description of embodiments of the present invention is provided in the following with reference to the accompanied drawings. It can be understood that the description and the accompanied drawings are provided for illustrative purposes only but not to limit the scope of the present invention.

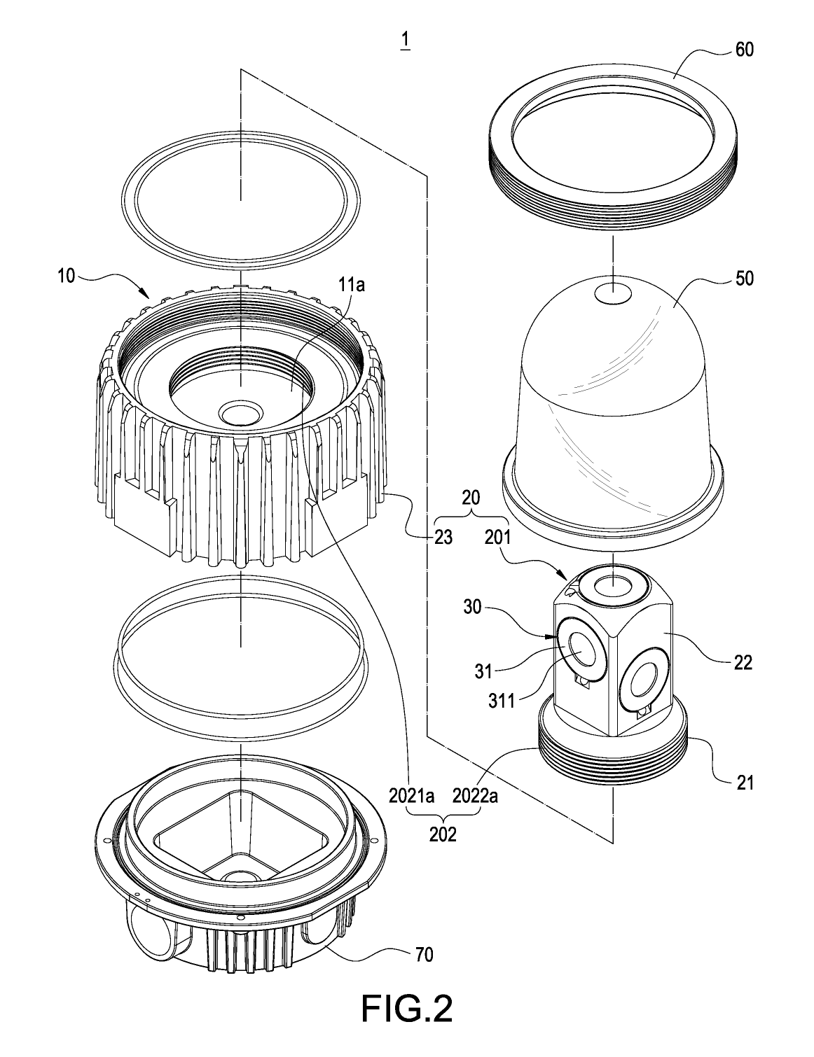

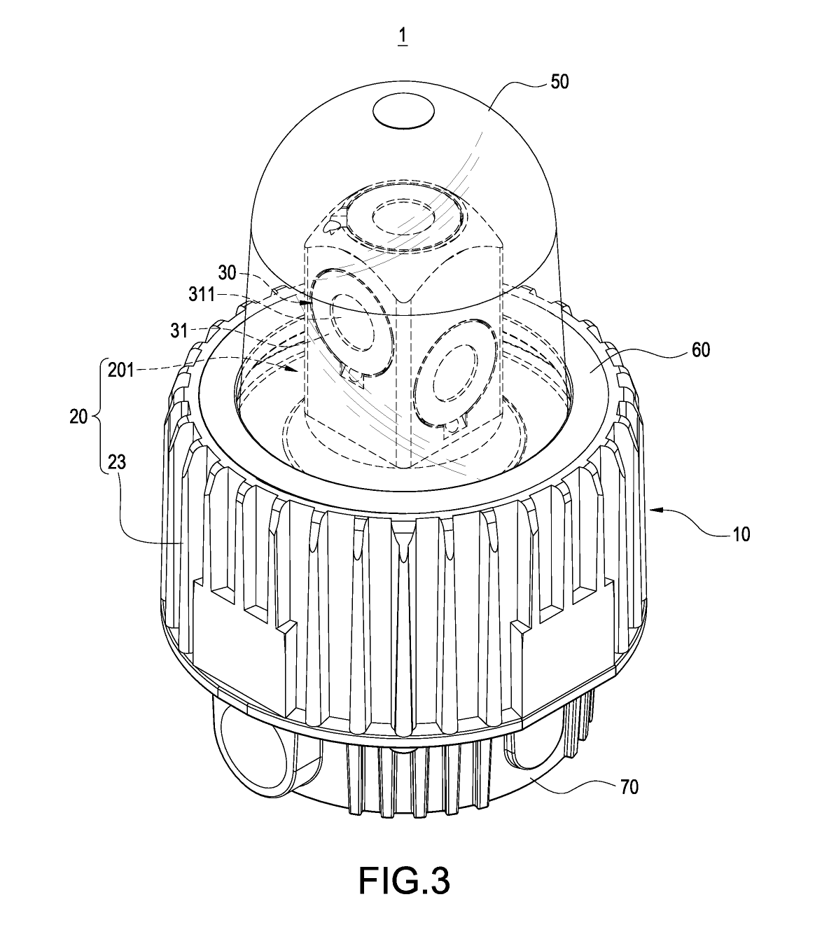

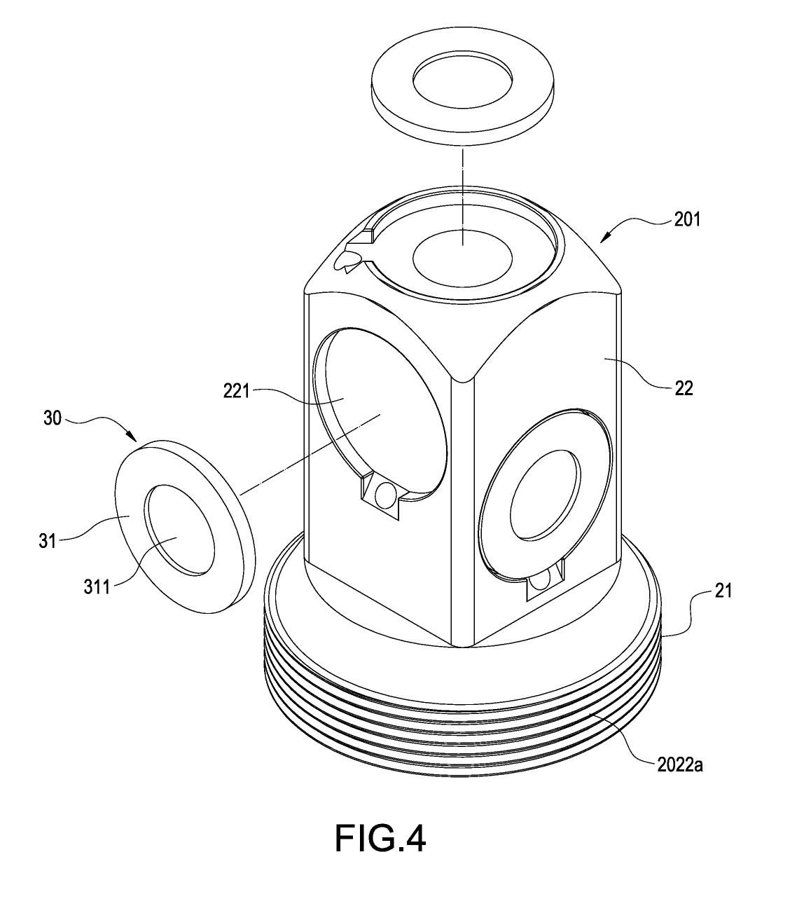

Please refer to FIG. 2 to FIG. 4, which show the exploded view, assembled perspective view of a first embodiment of the present invention and the perspective view of the heat dissipater respectively. The present invention provides an explosion-proof lamp with a heat dissipation mechanism 1 comprising a lamp base 10, a heat dissipater 20, a fastening means 202 and a lighting module 30.

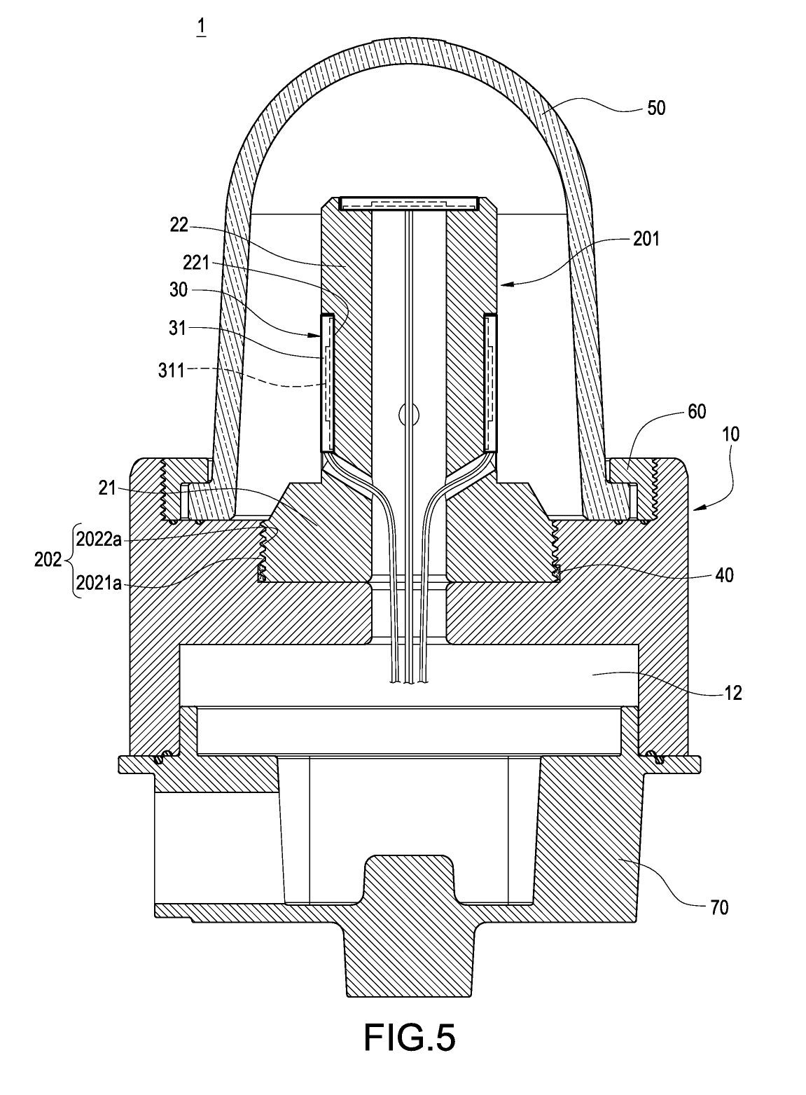

One end of the lamp base 10 is provided with a receiving room 11a and the other end thereof is provided with an electronic component chamber 12 as shown in FIG. 5.

The heat dissipater 20 comprises a heat dissipation body 201 and a plurality of heat dissipation fins 23. The heat dissipation body 201 comprises a foundation 21 and a column block 22. The foundation 21 is received in an internal of the receiving room 11a. The column block 21 is of an outer shape of a multi-edged block, a circular column block or a round ball block but is not limited to such shapes. The column block 21 extends from the foundation 21, and the cross-sectional size of the foundation 21 is greater than the cross-sectional size of the column block 22. The surface of the column block 22 comprises a plurality of indented grooves 221 and each one of the indented grooves 221 is arranged circumferentially to surround the column block 22. Each one of the heat dissipation fins 23 extends from the outer surface of the lamp base 10 and is arranged to radiate therefrom.

The fastening means 202 comprises an inner threaded portion 2021a and an outer threaded portion 2022a. The inner threaded portion 2021a is formed at the inner wall of the receiving room 11a of the lamp base 10, and the outer threaded portion 2022a is formed on the outer surface of the foundation 21. The inner threaded portion 2021a is matched with the outer threaded portion 2022a for fastening such that the foundation 21 is fastened firmly onto the lamp base 10.

The lighting module 30 comprises a plurality of lighting units 31, and each one of the lighting units 31 is an LED 331. Each one of the lighting units 31 is secured within each one of the indented grooves 221. The electronic component chamber 12 is provided to receive a driver of a lamp driving component 30 therein.

The explosion-proof lamp 1 further comprises a heat conductive medium 40 (as shown in FIG. 5), a light shell 50, a covering ring 60 and a cap 70. The heat conductive medium 40 is coated between the outer surface of the foundation 21 and the inner wall of the receiving room 11a in order to increase the contact area between the outer surface of the foundation 21 and the receiving room 11a such that the effect of the heat transfer is enhanced. The light shell 50 is secured onto the lamp base 10 and covers the column block 22 such that the light emitted from each one of the lighting units 30 is shone toward the light shell. The covering ring 60 covers the lamp base 10 in correspondence with the light shell 50 to force the light shell 50 to attach to the lamp base 10. The cap 70 is covered onto the lamp base 10 in correspondence with the electronic component chamber 12.

Please refer to FIG. 5 showing a cross-sectional view of an assembled first embodiment of the present invention. As each one of the lighting units 31 is directly secured within each one of the indented grooves 221 of the column block 22 and since the cross-sectional size of the column block 22 is smaller than the cross-sectional size of the foundation 21, the foundation 21 is of a greater heat accumulation capacity to allow the heat generated from the lighting units 31 to be transferred from the column block 22 to the foundation 21 in a fast rate and, finally, to be further transferred from the foundation 21 to each one of the heat dissipation fins 23 of the lamp base 10 via the outer threaded portion 2022a such that heat exchange with the air can be achieved via each one of the heat dissipation fins 23 to transfer the heat to the air in order to obtain the fast cooling effect of lowering the temperature of the lighting units 31 for an improved heat dissipation and such that the lighting units 31 are protected from damages due to the high temperature thereof for an increased useful lifetime.

In addition, by coating the heat conductive medium 40 between the outer surface of the foundation 21 and the inner wall of the receiving room 11a, the contact area between the outer surface of the foundation 21 and the receiving room 11a can be increased for an improved effect of heat transfer.

Furthermore, by securing each one of the lighting units 31 within each one of the indented grooves 221 of the column block 22, the lighting units 31 can be kept at a proper distance away from the light shell 50 such that such that the illumination of the explosion-proof lamp 1 is uniform. Also, one may alter the design of the heat dissipater 201 of the explosion-proof lamp 1 based on user's needs without remaking and molding of the explosion-proof lamp 1 all over again such that the costs and time required for molding designs, certifications and manufacturing can be significantly reduced, which can lower the storage quantity of the lamp base 10 and the cap 70, too.

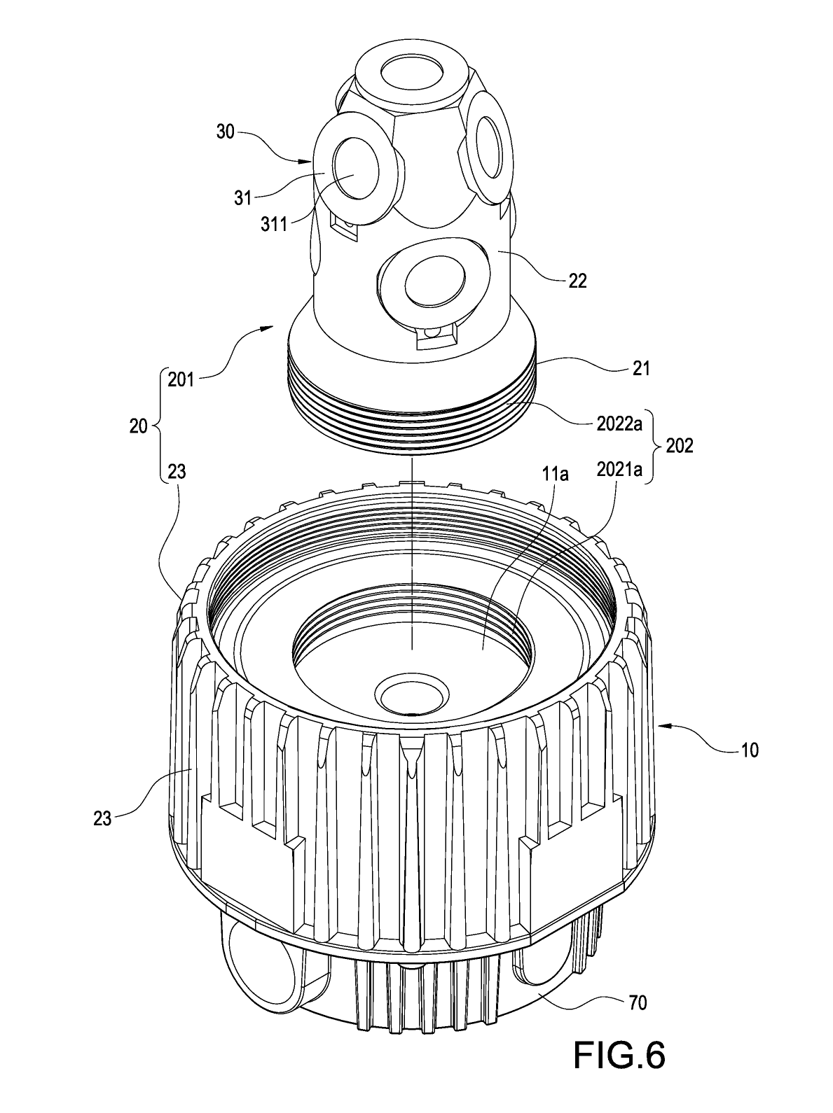

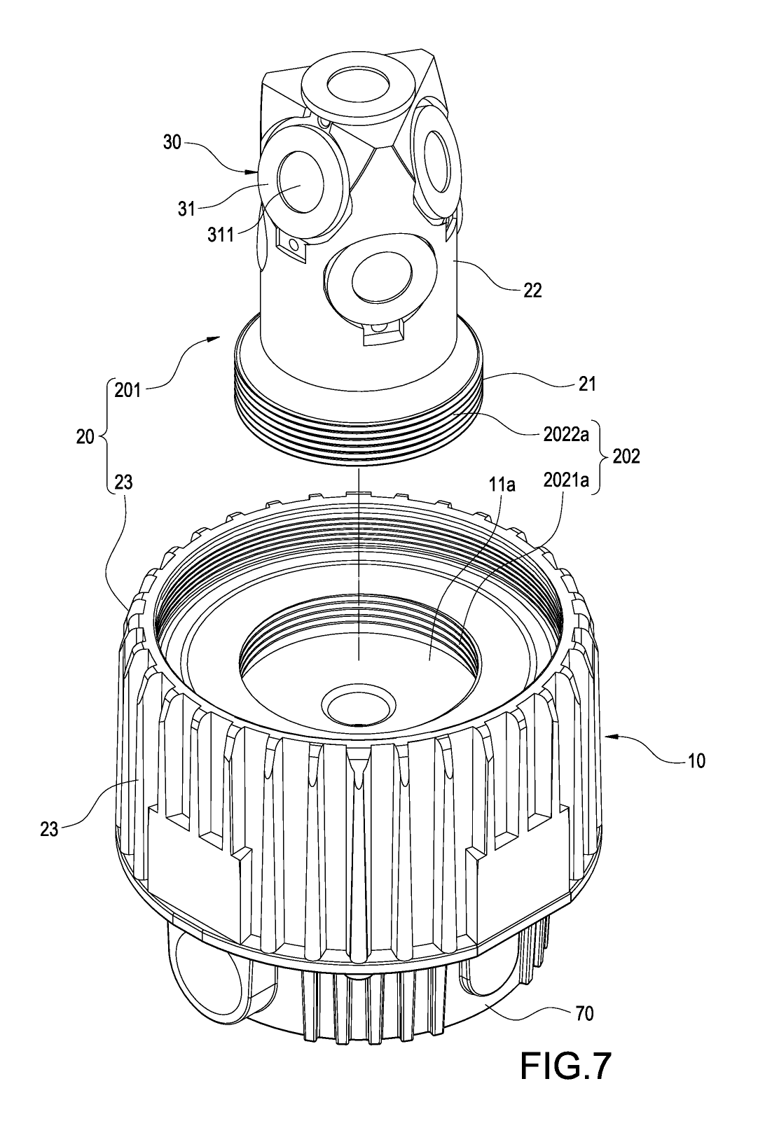

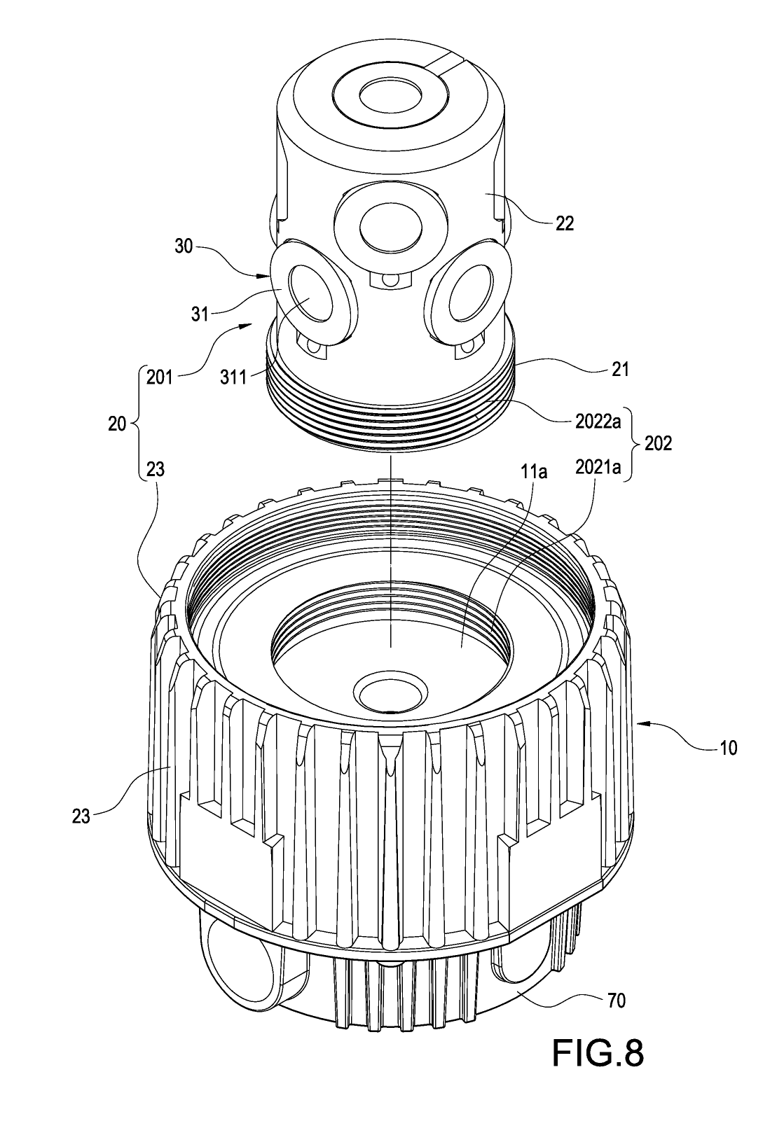

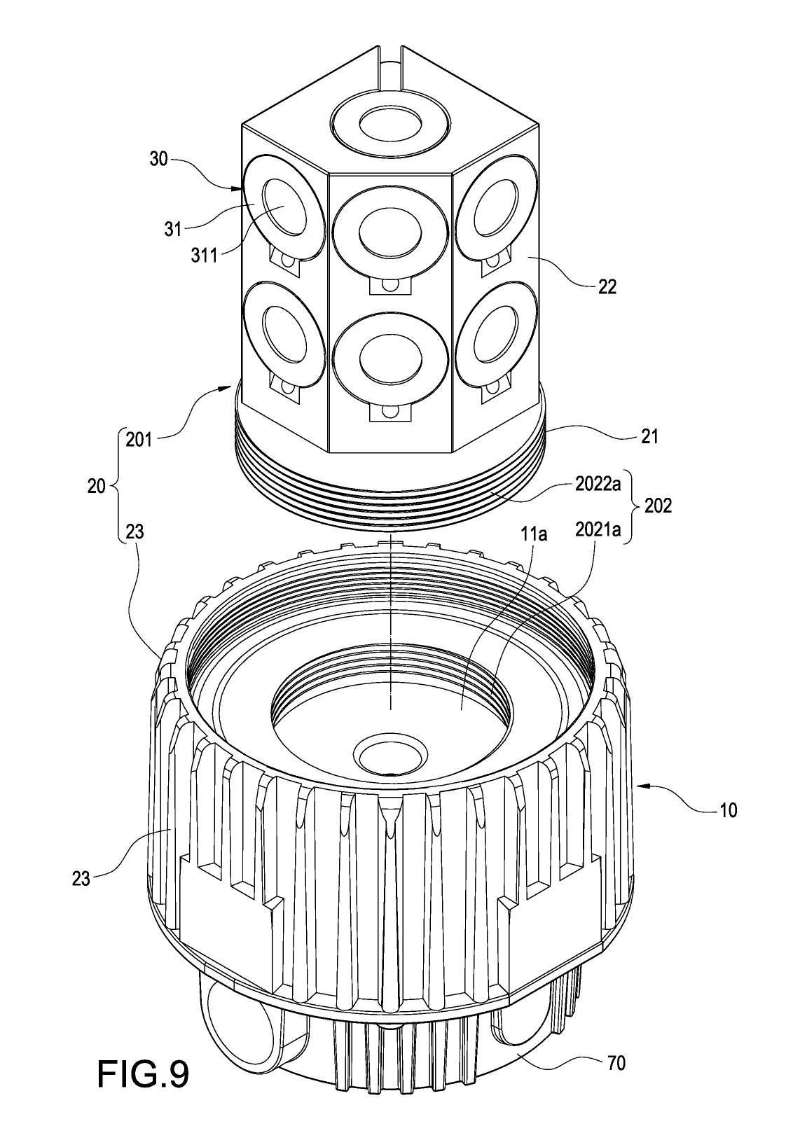

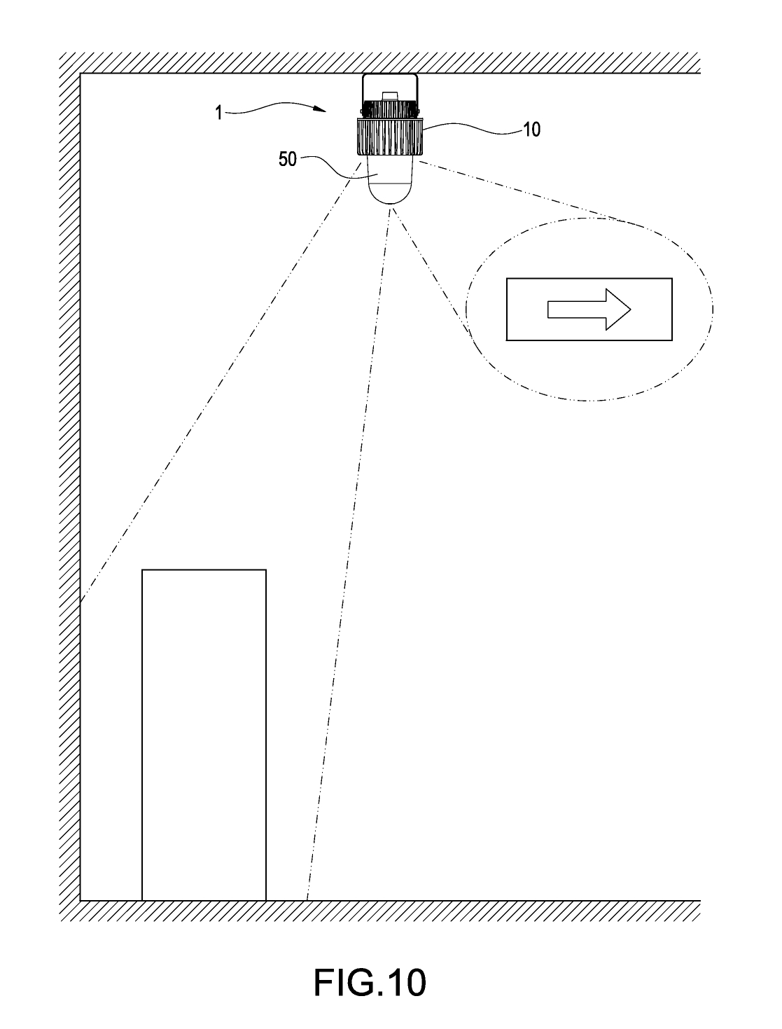

Please refer to FIG. 6 to FIG. 10 showing a first column block illustration, a second column block illustration, a third column block illustration and a fourth column block illustration of the first embodiment of the present invention and the state of use, respectively. According to different application locations and conditions of usages, the column block 22 can be designed to have different shapes and can be mounted with a different amount of lighting units 31 on the column block 22. In addition, the lighting units 31 can be secured onto the column block 22 partially or circumferentially to surrounding thereon to meet the requirement of different applications and the heat dissipater 201 can be exchanged in order to correspondingly generate different light distribution curves for the explosion-proof lamp 1 which is able to produce different illumination intensities, various lighting directions or multi-directional lights such that optimal illumination effects and applications can be achieved. Furthermore, it can effectively and optimally utilize the light provided by the lighting units 31 such that the effects of saving of energy and costs can be achieved, too. In addition, according to various requirements for different light source types and illumination, the indented grooves 221 can be made to have different sizes, depths and angles such that once the lighting units 31 are secured onto the column block 22, the light emitted from the lighting units 31 is able to shone to different angles and directions in order to produce an improved illumination effects.

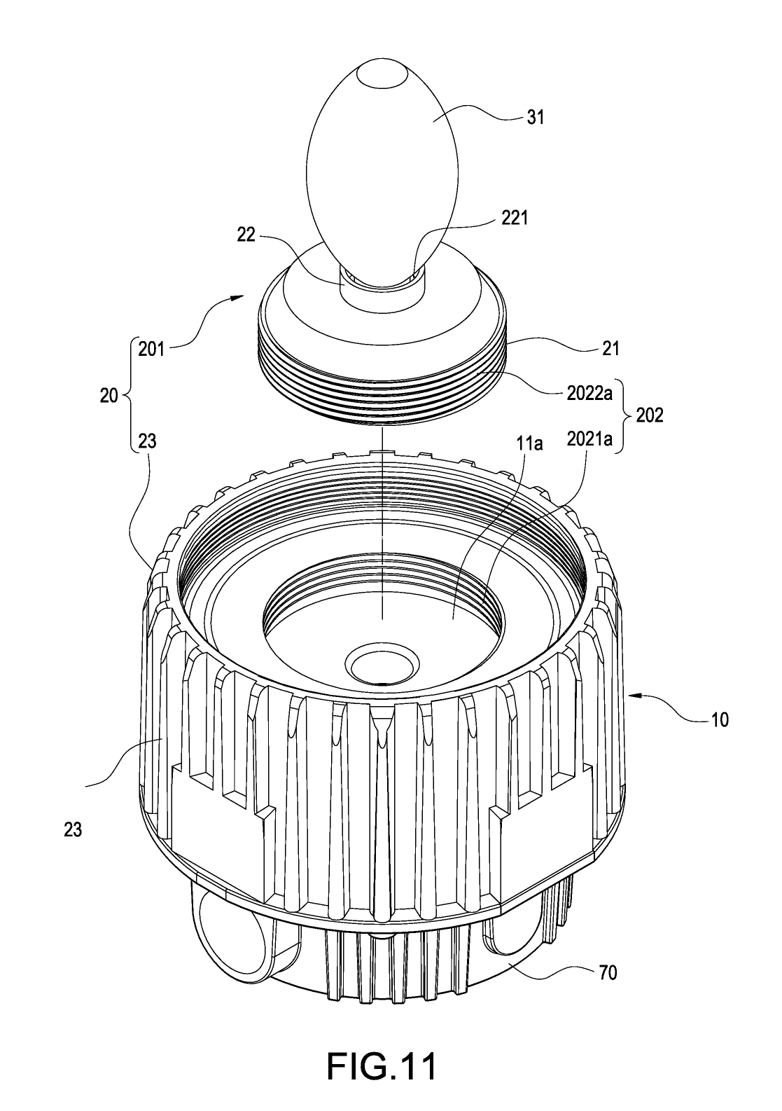

Please refer to FIG. 11 showing a perspective view of a second embodiment of the present invention, which differs from the aforementioned embodiment in that the lighting unit 31 can be a high-pressure sodium light bulb, a metal halide light bulb or other types of light bulb. The lighting unit 31 is attached to and secured within the indented slot 221 such that in the event of the damage of the lighting unit 31, it can be removed for replacement directly from the column block 22 of the heat dissipater 20 to facilitate the assembly and replacement of the lighting unit 31 with ease and to reduce the assembly time required.

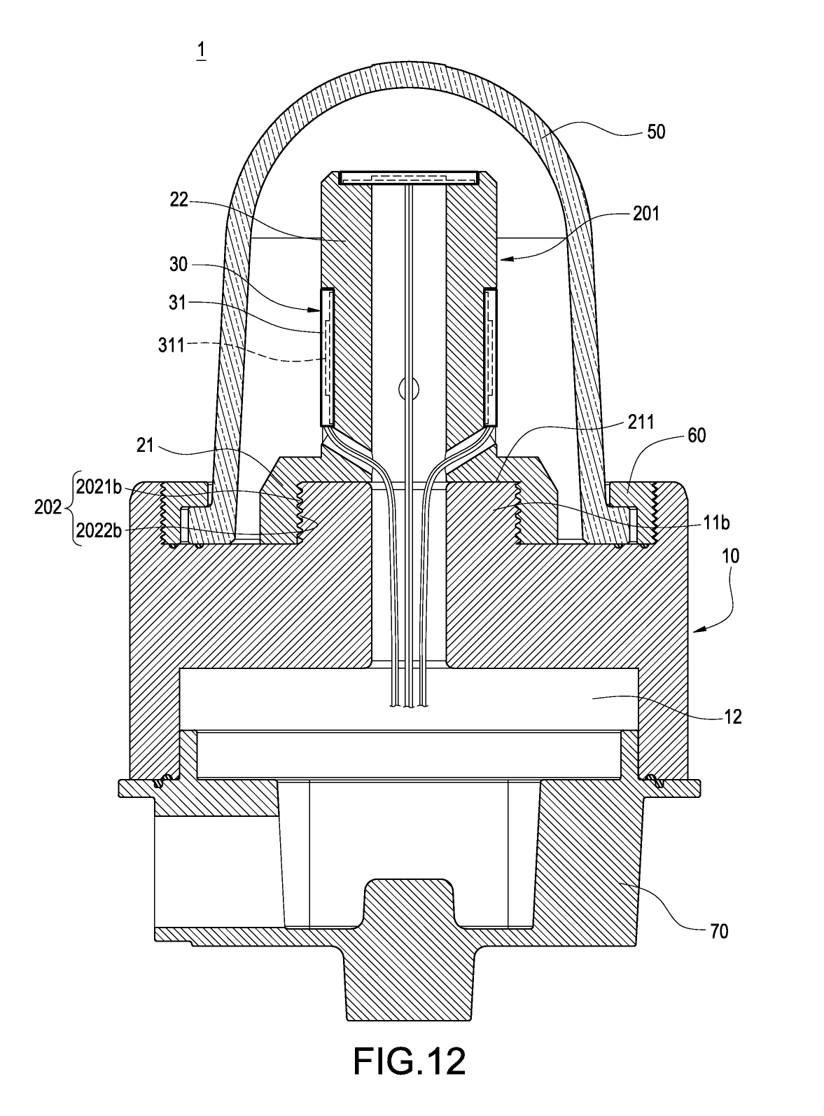

Please refer to FIG. 12 showing a cross-sectional view of an assembled third embodiment of the present invention, which differs from each one of the aforementioned embodiments in that a protrusion 11b is now being used for the receiving room 11a of the lamp base 10 shown in FIG. 2, an inner threaded portion 2021b is now being used for the inner threaded portion 2021a shown in FIG. 2 and an outer threaded portion 2022b is now being used for the outer threaded portion 2022a shown in FIG. 2. The protrusion 11b protrudes from the lamp base 10 and the outer threaded portion 2022b is formed on the outer surface of the protrusion 11b. The foundation 21 is provided with an opening slot 211 corresponding to the protrusion 11b. The inner threaded portion 2021b is formed on an inner wall of the opening slot 211. The inner threaded portion 2021b is fastened onto the outer threaded portion 2022b such that the protrusion 11b is firmly fastened within the opening slot 211 of the foundation 21 and such that the foundation 21 and the lamp base 10 are firmly fastened with each other.

In view of the above, it can be understood that the explosion-proof lamp with a heat dissipation mechanism of the present invention is of industrial applicability, novelty and inventive step. In addition, as the structure of the present invention is not seen in any known arts or publications, the present invention conforms to the requirements for patentability and the scope of the invention is defined in the appended claims.

What is claimed is:

1. An explosion-proof lamp with a heat dissipation mechanism, comprising:
a lamp base;
a heat dissipater comprising a heat dissipation body, said heat dissipation body comprising a foundation and a column block extended from said foundation, wherein a cross-sectional size of said foundation is greater than a cross-sectional size of said column block; and
a fastening means provided between said foundation and said lamp base, said foundation being screwed onto said lamp base via said fastening means; and
a lighting module secured onto said column block.

2. The explosion-proof lamp with a heat dissipation mechanism according to claim 1, wherein said lamp base further comprises a receiving room, and said fastening means comprises an inner threaded portion formed on an inner wall of said receiving room and an outer threaded portion formed on an outer surface of said foundation; wherein said inner threaded portion is matched with said outer threaded portion for fastening.

3. The explosion-proof lamp with a heat dissipation mechanism according to claim 1, wherein said lamp base comprises a protrusion protruded therefrom; said foundation is provided with an opening slot corresponding to said protrusion; said fastening means comprises an inner threaded portion formed on an inner wall of said opening slot and an outer threaded portion formed on an outer surface of said protrusion; wherein said inner threaded portion is matched with said outer threaded portion for fastening.

4. The explosion-proof lamp with a heat dissipation mechanism according to claim 1, wherein said lighting module comprises at least one lighting unit; a surface of said column block comprises an indented groove and said lighting unit is secured within said indented groove.

5. The explosion-proof lamp with a heat dissipation mechanism according to claim 1, wherein said lighting module comprises a plurality of lighting units; a surface of said column block comprises a plurality of indented grooves arranged circumferentially and each one of said plurality of lighting units is secured within said indented groove.

6. The explosion-proof lamp with a heat dissipation mechanism according to claim 4, wherein said lighting unit is a LED.

7. The explosion-proof lamp with a heat dissipation mechanism according to claim 5, wherein said lighting unit is a LED.

8. The explosion-proof lamp with a heat dissipation mechanism according to claim 4, wherein said lighting unit is a high-pressure sodium light bulb or a metal halide light bulb.

9. The explosion-proof lamp with a heat dissipation mechanism according to claim 1, wherein said column block is of an outer shape of a multi-edged block, a circular column block or a round ball block.

10. The explosion-proof lamp with a heat dissipation mechanism according to claim 2, further comprises a heat conductive medium; said heat conductive medium is coated between said inner wall of said receiving room and said outer surface of said foundation.

11. The explosion-proof lamp with a heat dissipation mechanism according to claim 3, further comprises a heat conductive medium; said heat conductive medium is coated between said outer surface of said protrusion and said inner wall of said opening slot.

12. The explosion-proof lamp with a heat dissipation mechanism according to claim 1, further comprises a light shell; said light shell is secured onto the lamp base and covers said column block.

13. The explosion-proof lamp with a heat dissipation mechanism according to claim 12, further comprises a covering ring; said covering ring covers said lamp base in correspondence with said light shell to force said light shell to attach to said lamp base.

14. The explosion-proof lamp with a heat dissipation mechanism according to claim 1, wherein said heat dissipater further comprises a plurality of heat dissipation fins; each one of said heat dissipation fins extends from an outer surface of said lamp base and is arranged to radiate therefrom.

15. The explosion-proof lamp with a heat dissipation mechanism according to claim 1, wherein said lamp base comprises an electronic component chamber provided on one end thereof away from said foundation.

16. The explosion-proof lamp with a heat dissipation mechanism according to claim 15, further comprises a cap; said cap is covered onto said lamp base in correspondence with said electronic component chamber.
